(19) United States
(12) Patent Application Publication
(10) Pub. No.: US 2013/0191323 A1
(43) Pub. Date: Jul. 25, 2013

(54) SYSTEM AND METHOD FOR IDENTIFYING THE CONTEXT OF MULTIMEDIA CONTENT ELEMENTS DISPLAYED IN A WEB-PAGE

(71) Applicant: Cortica, Ltd, Tirat Carmel (IL)

(72) Inventors: Igal Raichelgauz, Ramat Gan (IL); Karina Ordinaev, Ramat Gan (IL); Yehoshua Y. Zeevi, Haifa (IL)

(73) Assignee: CORTICA, LTD., Tirat Carmel (IL)

(21) Appl. No.: 13/770,603

(22) Filed: Feb. 19, 2013

Related U.S. Application Data
(63) Continuation-in-part of application No. 13/624,397, filed on Sep. 21, 2012.
Application No. 13/624,397 is a continuation-in-part of application No. 13/344,400, filed on Jan. 5, 2012.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009.
Application No. 13/624,397 is a continuation-in-part of application No. 12/084,150, filed on Apr. 7, 2009.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30592
USPC 707/603; 707/738; 707/600

(57) ABSTRACT

A method and system for determining a context of a web-page containing a plurality of multimedia content elements. The method comprises receiving a uniform resource locator (URL) of the web-page; downloading the web-page respective of the received URL; analyzing the web-page to identify the existence of each of the plurality of multimedia content elements; generating at least one signature for each of the plurality of multimedia content elements, wherein each of the generated signatures represents a concept; and correlating the concepts respective of the generated signatures to determine the context of each of the plurality of multimedia content elements, thereby determining the context of the web-page.

### CROSS-REFERENCE TO RELATED APPLICATIONS

This application is a continuation-in-part (CIP) of U.S. patent application Ser. No. 13/624,397 filed on Sep. 21, 2012, now pending. The Ser. No. 13/624,397 is a CIP of:
(a) U.S. patent application Ser. No. 13/344,400 filed on Jan. 5, 2012, now pending, which is a continuation of U.S. patent application Ser. No. 12/434,221, filed May 1, 2009, now U.S. Pat. No. 8,112,376;
(b) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,
(c) U.S. patent application Ser. No. 12/084,150 filed on Apr. 25, 2008, now pending, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006.
All of the applications referenced above are herein incorporated by reference for all that they contain.

### TECHNICAL FIELD

The present invention relates generally to the analysis of multimedia content displayed in a web-page, and more specifically to a system for identifying the context of the multimedia content.

### BACKGROUND

A web page is a document that is suitable for the World Wide Web and can be accessed through a web browser. Web pages generally contain other resources such as style sheets, scripts, and multimedia content elements in their final presentation. That is, media-rich web pages usually include information as to the colors of text, backgrounds, and links to multimedia content elements to be included in the final presentation when rendered by the web browser. A multimedia content element may include an image, graphics, a video stream, a video clip, an audio stream, an audio clip, and the like.

Web pages may consist of static or dynamic multimedia content elements retrieved from a web server's file system or by a web application. For example, a Facebook® page may include static images, such as a profile picture, and also dynamic contents of such pictures and/or video clips fed by other users.

In the related art there are different techniques for identifying the context of a web page. For example, the context may be determined based on the domain name of a web page mapped to a category (e.g., news, sports, etc.), textual analysis of the web page, or by information embedded in the web page by a programmer of the page. Although such techniques may be efficient in determining the context to static web pages, they cannot provide the current context of the web page that is dynamically changed. Further, the granularity of such context analysis may be in most cases, high level (e.g., news) without providing the context of the current content or topic (e.g., election of a particular candidate) presented in the web page.

Furthermore, there is no available solution to determine the context of a web page based on multimedia content elements presented therein and specifically, dynamic elements. Individual multimedia content elements in the web page can be extracted through the identification of a plurality of multimedia content elements, to determine that their respective context is not discussed in the related art. As noted above, in a web page some of the multimedia content elements are static, such as background colors or images. However, such images can provide little information about the current context of the information presented in the web page. The dynamic pictures really tell the story.

It would therefore be advantageous to provide a solution that would overcome the deficiencies of the prior art by identifying a plurality of elements within multimedia content and determining the context of the multimedia content.

### SUMMARY

Certain embodiments disclosed herein include a method for determining a context of a web-page containing a plurality of multimedia content elements. The method comprises receiving a uniform resource locator (URL) of the web-page; downloading the web-page respective of the received URL; analyzing the web-page to identify the existence of each of the plurality of multimedia content elements; generating at least one signature for each of the plurality of multimedia content elements, wherein each of the generated signatures represents a concept; and correlating the concepts respective of the generated signatures to determine the context of each of the plurality of multimedia content elements, thereby determining the context of the web-page.

Certain embodiments disclosed herein further include a system for determining a context of a web-page containing a plurality of multimedia content elements. The system comprises a processor communicatively connected to a network; a signature generator system (SGS) for generating at least one signature for each of the plurality of multimedia content elements, wherein each of the generated signatures represents a concept; and a context analyzer for correlating the concepts respective of the generated signatures to determine the context of each of the plurality of multimedia content elements, thereby determining the context of the web-page.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a network system utilized to describe the various embodiments disclosed herein;

FIG. 2 is a flowchart describing the process of matching an advertisement to multimedia content displayed on a web-page;

FIG. 3 is a block diagram depicting the basic flow of information in the signature generator system;

FIG. 4 is a diagram showing the flow of patches generation, response vector generation, and signature generation in a large-scale speech-to-text system;

FIG. 5 is a flowchart describing the process of adding an overlay to multimedia content displayed on a web-page; and

FIG. 6 is a flowchart describing a method for determining the context indicated by the relation between multimedia content elements displayed in a web-page according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein provide a system and method that determine the context of one or more multimedia content elements, or portions thereof. Accordingly, at least one signature is generated for each multimedia content element, or portion thereof displayed. Then, the signatures are analyzed to determine the concept of each of the signatures and the context of the one or more multimedia content elements respective thereto. In one embodiment, the one or more one or more multimedia content elements are extracted from a web-page.

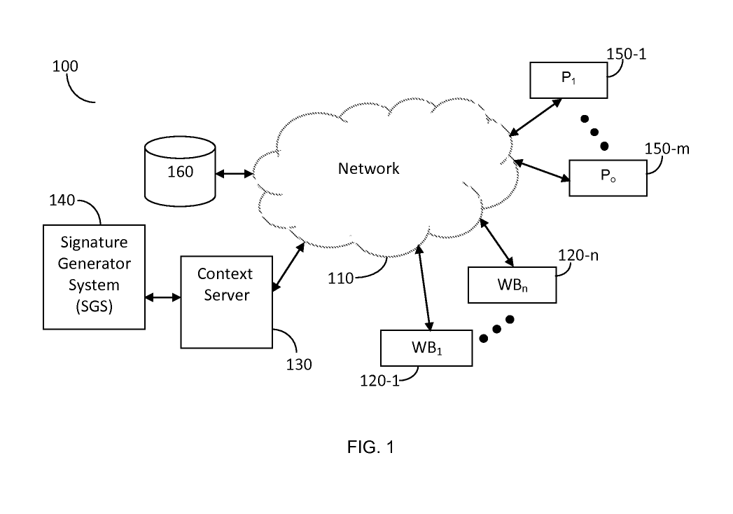

FIG. 1 shows an exemplary and non-limiting schematic diagram of a network system 100 utilized to describe the various embodiments disclosed herein. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

Further connected to the network 110 are one or more client applications, such as web browsers (WB) 120-1 through 120-n (collectively referred to hereinafter as web browsers 120 or individually as a web browser 120). A web browser 120 is executed over a computing device including, for example, a personal computer (PC), a personal digital assistant (PDA), a mobile phone, a smart phone, a tablet computer, and other kinds of wired and mobile appliances, equipped with browsing, viewing, listening, filtering, and managing capabilities etc., that are enabled as further discussed herein below.

The system 100 also includes a plurality of information sources 150-1 through 150-m (collectively referred to hereinafter as information sources 150 or individually as information sources 150) being connected to the network 110. Each of the information sources 150 may be, for example, a web server, an application server, a publisher server, an ad-serving system, a data repository, a database, and the like. Also connected to the network 110 is a data warehouse 160 that stores multimedia content elements, clusters of multimedia content elements, and the context determined for a web page as identified by its URL. In the embodiment illustrated in FIG. 1, a context server 130 communicates with the data warehouse 160 through the network 110. In other non-limiting configurations, the context sever 130 is directly connected to the data warehouse 160.

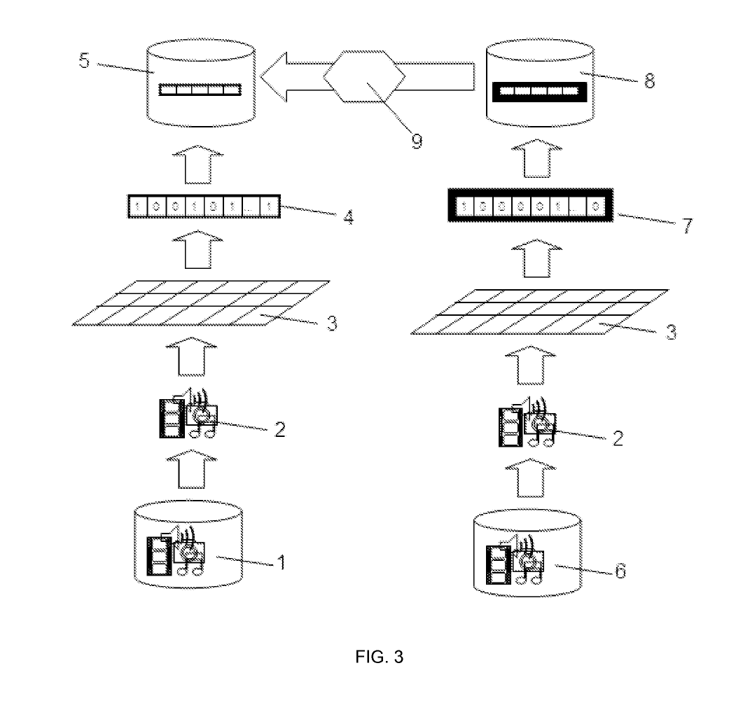

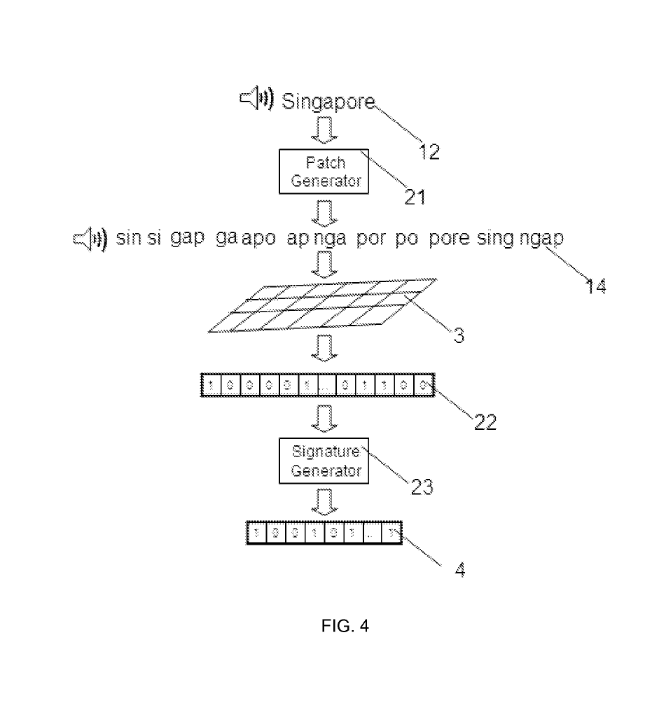

The various embodiments disclosed herein are realized using the context server 130 and a signature generator system (SGS) 140. The SGS 140 may be connected to the context server 130 directly or through the network 110. The context server 130 is enabled to receive and serve multimedia content elements and causes the SGS 140 to generate a signature respective of the multimedia content elements. The process for generating the signatures for multimedia content is explained in more detail herein below with respect to FIGS. 3 and 4. It should be noted that each of the context server 130 and the SGS 140, typically comprises a processing unit, such as a processor (not shown) that is coupled to a memory. The memory contains instructions that can be executed by the processing unit. The transaction of the context server 130 also includes an interface (not shown) to the network 110.

According to the disclosed embodiments, the context server 130 is configured to receive at least a URL of a web page hosted in an information source 150 and accessed by a web browser 120. The context server 130 is further configured to analyze the multimedia content elements contained in the web page to determine their context, thereby ascertaining the context of the web page. This is performed based on at least one signature generated for each multimedia content element. It should be noted that the context of an individual multimedia content element or a group of elements is extracted from the web page, received from a user of a web browser 120 (e.g., uploaded video clip), or retrieved from the data warehouse 160.

According to the embodiments disclosed herein, a user visits a web-page using a web-browser 120. When the web-page is uploaded on the user's web-browser 120, a request is sent to the context server 130 to analyze the multimedia content elements contained in the web-page. The request to analyze the multimedia content elements can be generated and sent by a script executed in the web-page, an agent installed in the web-browser, or by one of the information sources 150 (e.g., a web server or a publisher server) when requested to upload one or more advertisements to the web-page. The request to analyze the multimedia content may include a URL of the web-page or a copy of the web-page. In one embodiment, the request may include multimedia content elements extracted from the web-page. A multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof.

The context server 130 analyzes the multimedia content elements in the web-page to determine their context. For example, if the web page contains images of palm trees, a beach, and the coast line of San Diego, the context of the web page may be determined to be “California sea shore.” According to one embodiment, the determined context can be utilized to detect one or more matching advertisements for the multimedia content elements. According to this embodiment, the SGS 140 generates for each multimedia content element provided by the context server 130 at least one signature. The generated signature(s) may be robust to noise and distortion as discussed below. Then, using the generated signature(s) the context server 130, determines the context of the elements and searches the data warehouse 160 for a matching advertisement based on the context. For example, if the signature of an image indicates a “California sea shore”, then an advertisement for a swimsuit can be a potential matching advertisement.

It should be noted that using signatures for determining the context and thereby for the searching of advertisements ensures more accurate reorganization of multimedia content than, for example, when using metadata. For instance, in order to provide a matching advertisement for a sports car it may be desirable to locate a car of a particular model. However, in most cases the model of the car would not be part of the metadata associated with the multimedia content (image). Moreover, the car shown in an image may be at angles different from the angles of a specific photograph of the car that is available as a search item. The signature generated for that image would enable accurate recognition of the model of the car because the signatures generated for the multimedia content elements, according to the disclosed embodiments, allow for recognition and classification of multimedia content elements, such as, content-tracking, video filtering, multimedia taxonomy generation, video fingerprinting, speech-to-text, audio classification, element recognition, video/image search and any other application requiring content-based signatures generation and matching for large content volumes such as, web and other large-scale databases.

In one embodiment, the signatures generated for more than one multimedia content element are clustered. The clustered signatures are used to determine the context of the web page and to search for a matching advertisement. The one or more selected matching advertisements are retrieved from the data warehouse 160 and uploaded to the web-page on the web browser 120.

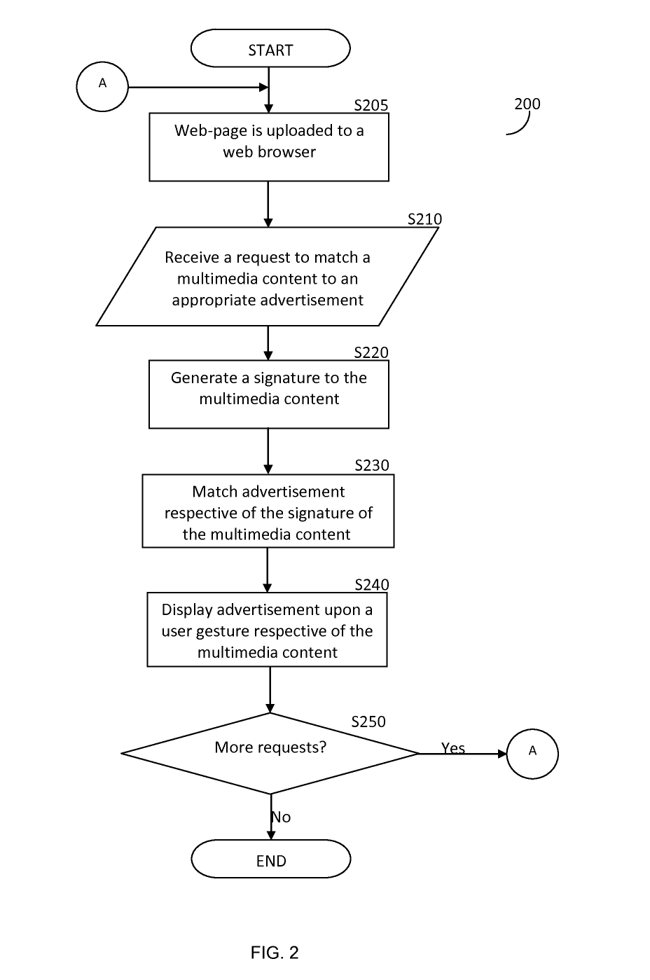

FIG. 2 depicts an exemplary and non-limiting flowchart 200 describing the process of matching an advertisement to multimedia content displayed on a web-page. At S205, the method starts when a web-page is uploaded to one of the web-browsers (e.g., web-browser 120-1). In S210, a request to match at least one multimedia content element contained in the uploaded web-page to an appropriate advertisement item is received. The request can be received from a publisher server, a script running on the uploaded web-page, or an agent (e.g., an add-on) installed in the web-browser. S210 can also include extracting the multimedia content elements for a signature that should be generated.

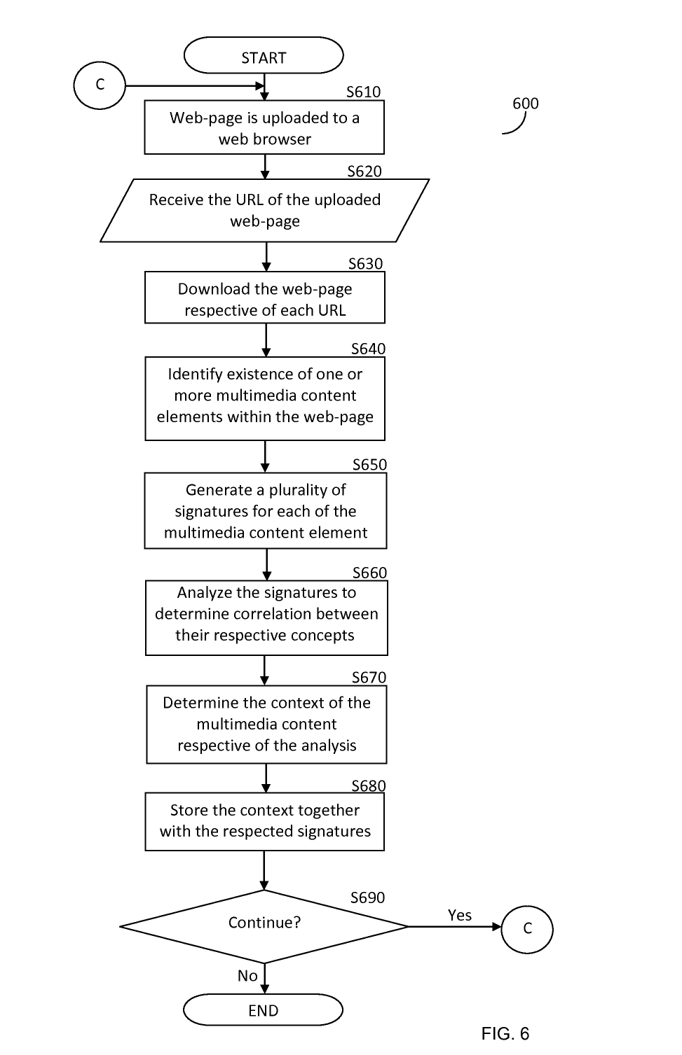

In S220, at least one signature for the multimedia content element executed from the web page is generated. The signature for the multimedia content element generated by a signature generator is described below with respect to FIGS. 3 and 4. In one embodiment, based on the generated signatures, the context of the extracted multimedia content elements, and thereby the web page, is determined as described below with respect to FIG. 6.

In S230, an advertisement item is matched to the multimedia content element respective of its generated signatures and/or the determined context. According to one embodiment, the matching process includes searching for at least one advertisement item respective of the signature of the multimedia content and a display of the at least one advertisement item within the display area of the web-page. According to another embodiment, the signatures generated for the multimedia content elements are clustered and the cluster of signatures is matched to one or more advertisement items. According to yet another embodiment, the matching of an advertisement to a multimedia content element can be performed by the computational cores that are part of a large scale matching discussed in detail below.

In S240, upon a user's gesture the advertisement item is uploaded to the web-page and displayed therein. The user's gesture may be: a scroll on the multimedia content element, a press on the multimedia content element, and/or a response to the multimedia content. This ensures that the user's attention is given to the advertised content. In S250, it is checked whether there are additional requests to analyze multimedia content elements, and if so, execution continues with S210; otherwise, execution terminates.

As a non-limiting example, an image that contains a plurality of multimedia content elements is identified by the context server 130 in an uploaded web-page. The SGS 140 generates at least one signature for each multimedia content element executed from the image that exists in the web page. According to this embodiment a printer and a scanner are shown in the image and the SGS 140 generates signatures respective thereto. The server 130 is configured to determine that the context of the image is office equipment. Therefore, the context server 130 is configured to match at least one advertisement suitable for office equipment.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the context server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame T is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = • ( Vi - {Th}_{x} )$$

where, □ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Thₛ) and Robust Signature (Th_{RS}) are set apart, after optimization, according to at least one or more of the following criteria:
1: For: Vᵢ>Th_{RS}
   1−p(V>Th_{S})−1−(1−ε)^{l}≦≦1

i.e., given that l nodes (cores) constitute a Robust Signature of a certain image I, the probability that not all of these l nodes will belong to the Signature of same, but noisy image, [symbol] is sufficiently low (according to a system's specified accuracy).

2: p(Vᵢ>Th_{RS})≈l/L

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the co-pending U.S. patent application Ser. No. 12/084,150 referenced above.

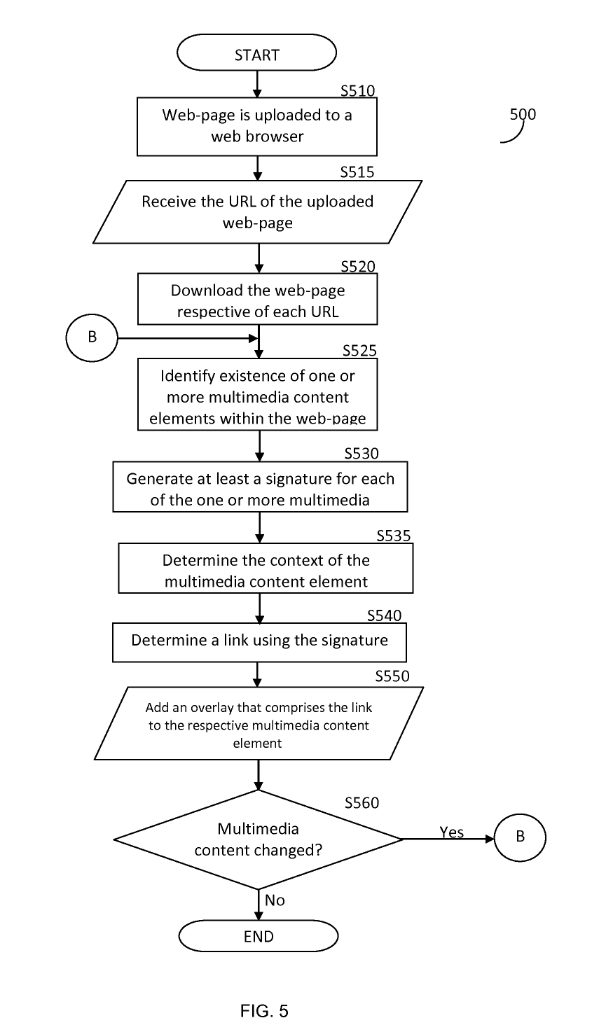

FIG. 5 depicts an exemplary and non-limiting flowchart 500 describing the process of adding an overlay to multimedia content displayed on a web-page according to one embodiment. In S510, the method starts when a web-page is uploaded to a web-browser (e.g., web-browser 120-1). In another embodiment, the method starts when a web-server (e.g., web-server 150-1) receives a request to host the requested web-page. In S515, the context server 130 receives the uniform resource locator (URL) of the uploaded web-page. In another embodiment, the uploaded web-page includes an embedded script. The script extracts the URL of the web-page, and sends the URL to the context server 130. In another embodiment, an add-on installed in the web-browser 120 extracts the URL of the uploaded web-page, and sends the URL to the context server 130. In yet another embodiment, an agent is installed on a user device executing the web browser 120. The agent is configured to monitor web-pages uploaded to the web-site, extract the URLs, and send them to the server context 130. In another embodiment, a web-server (e.g., server 150) hosting the requested web-page, provides the context server 130 with the URL of the requested web-page. It should be noted that only URLs of selected web sites can be sent to the context server 130, for example, URLs related to web-sites that paid for the additional information.

In S520, the server downloads the web-page respective of each received URL. In S525, the context server 130 analyzes the web-page in order to identify the existence of at least one or more multimedia content elements in the uploaded web-page. It should be understood that a multimedia content element, such as an image or a video, may include a plurality of multimedia content elements. In S530, the SGS 140 generates for each multimedia content element identified by the context server 130, at least one signature. The signatures for the multimedia content elements are generated as described in greater detail above.

In S535, respective of each signature, the context server 130 determines the context of the multimedia content element. The determination of context based on the signatures is discussed in more detail below. In S540, respective of the context or the signature of the elements, the server 130 determines one or more links to content that exist on a web server, for example, an information source 150 that can be associated with the multimedia content element. A link may be a hyperlink, a URL, and the like to external resource information.

That is, the content accessed through the link may be, for example, informative web-pages such as the Wikipedia® website. The determination of the link may be made by identification of the context of the signatures generated by the context server 130. As an example, if the context of the multimedia content elements was identified as a football player, then a link to a sports website that contains information about the football player is determined.

In S550, the determined link to the content is added as an overlay to the web-page by the context server 130, respective of the corresponding multimedia content element. According to one embodiment, a link that contains the overlay may be provided to a web browser (e.g., browser 120-1) respective of a user's gesture. A user's gesture may be: a scroll on the multimedia content element, a click on the at least one multimedia content element, and/or a response to the at least one multimedia content or portion thereof.

The modified web-page that includes at least one multimedia content element with the added link can be sent directly to the web browser 120-1 requesting the web-page. This requires establishing a data session between the context server 130 and the web browsers 120. In another embodiment, the multimedia element including the added link is returned to a web server (e.g., source 150) hosting the requested web-page. The web server returns the requested web-page with the multimedia element containing the added link to the web browser 120-1 requesting the web-page. Once the “modified” web-page is displayed over the web browser 120-1, a detected user's gesture over the multimedia element would cause the web browser 120-1 to upload the content (e.g., a Wikipedia web-page) accessed by the link added to the multimedia element.

In S560, it is checked whether the one or more multimedia content elements contained in the web-page has changed, and if so, execution continues with S525; otherwise, execution terminates.

As a non-limiting example, a web-page containing an image of the movie “Pretty Woman” is uploaded to the context server 130. A signature is generated by the SGS 140 respective of the actor Richard Gere and the actress Julia Roberts, both shown in the image. The context of the signatures according to this example may be “American Movie Actors”. An overlay containing the links to Richard Gere's biography and Julia Roberts' biography on the Wikipedia® website is added over the image such that upon detection of a user's gesture, for example, a mouse clicking over the part of the image where Richard Gere is shown, the link to Richard Gere's biography on Wikipedia® is provided to the user.

According to another embodiment, a web-page that contains an embedded video clip is requested by a web browser 120-1 from an information source 150-1 and a banner advertising New York City. The context server 130 receives the requested URL. The context server 130 analyzes the video content and the banner within the requested web-page and a signature is generated by the SGS 140 respective of the entertainer Madonna that is shown in the video content and the banner. The context of multimedia content embedded in the web page is determined to be “live pop shows in NYC.” In response to the determined context, a link to a hosted web site for purchasing show tickets is added as an overlay to the video clip. The web-page together with the added link is sent to a web server (e.g., an information source 150-1), which then uploads the requested web-page with the modified video element to the web-browser 120-1.

The web-page may contain a number of multimedia content elements; however, in some instances only a few links may be displayed in the web-page. Accordingly, in one embodiment, the signatures generated for the multimedia content elements are clustered and the cluster of signatures is matched to one or more advertisement items.

FIG. 6 describes the operation of determining a context of a multimedia content according to one embodiment. In S610, the method starts when a web-page is uploaded to a web-browser (e.g., web-browser 120-1). In another embodiment, the method starts when a web server (e.g., web-browser 150-1) receives a request to host the requested web-page.

In S620, the context server 130 receives the uniform resource locator (URL) of the web-page to be processed. In another embodiment, the uploaded web-page includes an embedded script. The script extracts the URL of the web-page, and sends the URL to the context server 130. In another embodiment, an add-on installed in the web-browser 120 extracts the URL of the uploaded web-page, and sends the URL to the context server 130. In yet another embodiment, an agent is installed on a user device executing the web browser 120. The agent is configured to monitor web-pages uploaded to the web-site, extract the URLs, and send them to the context server 130. In another embodiment, the web-server (e.g., an information source 150-1) hosting the requested web-page, provides the context server 130 with the URL of the requested web-page. It should be noted that only URLs of selected web sites can be sent to the context server 130, for example, URLs related to web-sites that paid for the additional information.

In S630, the server downloads the web-page respective of each received URL. In S640, the server 130 analyzes the web-page in order to identify the existence of one or more multimedia content elements in the uploaded web-page. Each identified multimedia content element is extracted from the web-page and sent to the SGS 140. In S650, the SGS 140 generates for each multimedia content element identified by the context server 130 at least one signature. The at least one signature is robust for noise and distortion. The signatures for the multimedia content elements are generated as described in greater detail above. It should also be noted that signatures can be generated for portions of a multimedia content element.

In S660, the context server 130 analyzes the correlation between the signatures of all extracted multimedia content elements, or portions thereof. Specifically, each signature represents a different concept. The signatures are analyzed to determine the correlation concepts. A concept is an abstract description of the content to which the signature was generated. For example, a concept of the signature generated for a picture showing a bouquet of red roses is “flowers”. The correlation between concepts can be achieved by identifying a ratio between signatures' sizes, a spatial location of each signature, and so on using probabilistic models. As noted above a signature represents a concept and is generated for a multimedia content element. Thus, identifying, for example, the ratio of signatures' sizes may also indicate the ratio between the size of their respective multimedia elements.

A context is determined as the correlation between a plurality of concepts. A strong context is determined when there are more concepts, or the plurality of concepts, satisfy the same predefined condition. As an example, the server 130 analyzes signatures generated for multimedia content elements of a smiling child with a Ferris wheel in the background. The concept of the signature of the smiling child is “amusement” and the concept of a signature of the Ferris wheel is “amusement park”. The server 130 further analyzes the relation between the signatures of the child and recognized wheel, to determine that the Ferris wheel is bigger than the child. The relation analysis determines that the Ferris wheel is used to entertain the child. Therefore, the determined context may be “amusement.”

According to one embodiment, the context server 130 uses one or more typically probabilistic models to determine the correlation between signatures representing concepts. The probabilistic models determine, for example, the probability that a signature may appear in the same orientation and in the same ratio as another signature. When performing the analysis, the context server 130 utilizes information maintained in the data warehouse 160, for example, signatures previously analyzed. In S670, the context server 130 determines, based on the analysis performed in S660, the context of a plurality of multimedia content elements that exist in the web-page and in the context of the web-page.

As an example, an image that contains a plurality of multimedia content elements is identified by the context server 130 in an uploaded web-page. The SGS 140 generates at least one signature for each of the plurality of multimedia content elements that exist in the image. According to this example, the multimedia contents of the singer “Adele”, “red carpet” and a “Grammy” award are shown in the image. The SGS 140 generates signatures respective thereto. The context server 130 analyzes the correlation between “Adele”, “red carpet” and a “Grammy” award and determines the context of the image based on the correlation. According to this example such a context may be “Adele Wining the Grammy Award”.

Following is another non-limiting example demonstrating the operation of the server 130. In this example, a web page containing a plurality of multimedia content elements is identified by the context server 130 in an uploaded web-page. According to this example, the SGS 140 generates signatures for the objects such as, a “glass”, a “cutlery” and a “plate” which appear in the multimedia elements. The context server 130 then analyzes the correlation between the concepts generated by signatures respective of the data maintained in the data warehouse 160, for example, analysis of previously generated signatures. According to this example, as the all concepts of the “glass”, the “cutlery”, and the “plate” satisfy the same predefined condition, a strong context is determined. The context of such concepts may be a “table set”. The context can be also determined respective of a ratio of the sizes of the objects (glass, cutlery, and plate) in the image and the distinction of their spatial orientation.

In S680, the context of the multimedia content together with the respective signatures is stored in the data warehouse 160 for future use. In S690, it is checked whether there are additional web-pages and if so execution continues with S610; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining a context of a web-page containing a plurality of multimedia content elements, comprising:
receiving a uniform resource locator (URL) of the web-page;
downloading the web-page respective of the received URL;
analyzing the web-page to identify the existence of each of the plurality of multimedia content elements;
generating at least one signature for each of the plurality of multimedia content elements, wherein each of the generated signatures represents a concept; and
correlating the concepts respective of the generated signatures to determine the context of each of the plurality of multimedia content elements, thereby determining the context of the web-page.

2. The method of claim 1, wherein the concept is an abstract description of a multimedia content element to which the signature is generated.

3. The method of claim 2, further comprising:
storing in a data warehouse the at least determined context.

4. The method of claim 3, further comprising:
maintaining in the data warehouse the at least one signature generated for each of the plurality of multimedia content elements.

5. The method of claim 4, further comprising:
identifying one or more portions of multimedia content in each of the plurality of multimedia content elements;
generating at least one signature for each of the identified portions;
analyzing the at least one signature using at least one of the previously generated signatures maintained in the data warehouse; and
determining the context of the multimedia content element based on the signatures and the analysis.

6. The method of claim 1, wherein the correlation of the concepts is performed using at least one probabilistic model.

7. The method of claim 1, wherein the at least one signature is robust to noise and distortion.

8. The method of claim 1, wherein each of the plurality of multimedia content elements is at least one of: an image, graphics, a video stream, a video clip, an audio stream, an audio clip, a video frame, a photograph, images of signals, and portions thereof.

9. A non-transitory computer readable medium having stored thereon instructions for causing one or more processing units to execute the method according to claim 1.

10. A system for determining a context of a web-page containing a plurality of multimedia content elements, comprising:
a processor communicatively connected to a network;
a signature generator system (SGS) for generating at least one signature for each of the plurality of multimedia content elements, wherein each of the generated signatures represents a concept; and
a context analyzer for correlating the concepts respective of the generated signatures to determine the context of each of the plurality of multimedia content elements, thereby determining the context of the web-page.

11. The system of claim 10, further comprises:
a data warehouse for maintaining the at least determined context and the at least one signature generated for each of the plurality of multimedia content elements.

12. The system of claim 11, wherein the context analyzer is further configured to:
identify one or more portions of multimedia content in each of the plurality of multimedia content elements;
generate at least one signature for each of the identified portions;
analyze the at least one signature using at least one previously generated signature maintained in the data warehouse; and
determine the context of the multimedia content element based on the signatures and the analysis.

13. The system of claim 10, wherein the context analyzer is further configured to correlate the concepts using at least one probabilistic model.

14. The server of claim 10, wherein the at least one signature is robust to noise and distortion.

15. The server of claim 10, wherein each of the plurality of multimedia content elements is at least one of: an image, graphics, a video stream, a video clip, an audio stream, an audio clip, a video frame, a photograph, images of signals, combinations thereof, and portions thereof.

16. The server of claim 10, wherein the signature generator system (SGS) further comprises:
a plurality of computational cores enabled to receive the at least a multimedia content element, each computational core of the plurality of computational cores having properties that are at least partly statistically independent of other of the computational cores, the properties are set independently of each other core.
